(19) United States
(12) Patent Application Publication
(10) Pub. No.: US 2004/0009449 A1
(43) Pub. Date: Jan. 15, 2004

(54) Removable expansion appliance

(76) Inventors: James Mah, Hermosa Beach, CA (US); Brian Walter Lotte, Hermosa Beach, CA (US)

Correspondence Address: JAMES K. MAH, 62 THE STRAND, HERMOSA BEACH, CA, 90254, US

(21) Appl. No.: 10/192,305

(22) Filed: Jul. 9, 2002

(51) Int. Cl. A61C 3/00

(52) U.S. Cl. 433/7; 433/6

(57) ABSTRACT

This invention describes a thin, substantially clear removable expansion appliance used in the field of orthodontics and dentistry. The removable expansion appliance comprises a polymeric tray with tooth receiving cavities intended to receive a patient's dentition and an expansion mechanism attached to the tray capable of producing forces perpendicular to the patient's palatal suture. Preferably, the tray has at least two lingually positioned protrusions. Each protrusion comprises a hole intended to receive a prong located at the end of a leg of the expansion mechanism. Alternatively, the prongs of the expansion mechanism are bonded to the tray with acrylic. The expansion mechanism either produces the desired expansion forces by compression of a length of wire when the appliance is placed on the patient's dentition, or by utilizing a screw for rigidly expanding the patient's arch.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### FIELD OF INVENTION

The present invention relates to the field of orthodontics and dentistry. More specifically, this invention relates to the design, manufacture and use of a thin, aesthetic polymeric orthodontic appliance with an expansion mechanism that fits over a patient's dental set and is capable of expanding a patient's dental arch.

### BACKGROUND OF INVENTION

Orthodontic treatment entails the discipline of dentistry involved with tooth movement for the correction of tooth misalignment and growth discrepancies of the jaws. Generally, a practitioner utilizes orthodontic appliances to move a patient's dental set from an original, mal-occluded position to a final position. The goal of orthodontic treatment is to produce a more aesthetic facial appearance and to improve biomechanical functions involving the patient's mouth.

In some patients with malocclusion, the upper or lower jaw is of insufficient width for proper function and/or esthetic appearance. The treatment of this problem is by expanding the jaw with an orthodontic appliance or with a surgical operation to widen the jaw. In younger, growing patients where the bone has not fully matured, jaw expansion with an orthodontic appliance is commonly used and is very successful. At this time the bones and tissues are sufficiently pliable such that they are responsive to mechanical forces applied with orthodontic appliances and remodel to correct the problem.

Orthodontic benefits from correcting an overly narrow maxillary palate include increasing space to ease tooth alignment, correcting dental occlusion, widening of the cheek bones for general facial aesthetics, and opening up of the airway and nasal passages to improve breathing. Generally, practitioners expand the maxillary palate at a rate of between 0.25 mm and 1 mm per day. The treatment is particularly successful in the upper jaw of a young patient as there is an open suture between the right and left sides. This suture consists of fibrous tissue and is easily split apart. With growth and development, this suture is gradually filled in with bone and eventually becomes inseparable in adulthood. In adults, since the suture in the upper jaw is filled in with bone, surgery is performed to separate the bony components allowing for expansion using this appliance.

Orthodontic appliances to expand jaws include both fixed and removable varieties. Fixed expanders are adhered to the dental anatomy with specialized adhesives, or attached to bands bonded to the patient's teeth. Removable expanders are generally constructed similarly to retainers, with an expansion mechanism embedded in the acrylic of the appliance.

One type of fixed expander is mounted to the patient's teeth using four metal barrel bands mounted respectively on the opposing first molars and second premolars. Heavy gauge wire fastens the barrel bands on the same side together as well as to respective sides of a centrally located jackscrew assembly. The left and right bands are expanded away from each other by turning the centrally located jackscrew. Since the right and left sides of the centrally located jackscrew assembly are rigidly attached to the premolar and molar, activation of the screw will push the right and left sides of the jaw apart. In some cases, where the premolar is unerupted, a primary molar is used instead. In any case, the premolar and molars are sufficiently anchored into the jawbone that the forces applied to them are transferred to the jawbone. This appliance is typically activated by an informed parent using a key to turn the centrally located jackscrew assembly, expanding at a rate of 0.25 mm to 0.5 mm per day. The activation period is typically one to two weeks, after which, the appliance is no longer activated but left in the patient's mouth to allow bone to fill in the suture and prevent relapse.

The problems associated with this type of fixed exander are patient discomfort, speech difficulties, and oral hygiene since it covers a substantial portion of the roof of the mouth. Additionally, the metal barrel bands, especially those towards the anterior of the mouth can be seen and are considered unaesthetic by patients, particularly adults. Additionally, the clinical procedure for applying this type of fixed expander is fairly extensive. First, the molars must be separated in order to allow room in the interproximal areas for the molar bands. Molar bands and or bicuspid bands are then bonded to the appropriate teeth and the appliance is inserted. The fit of the appliance must then be checked. Band cement washout and failure is a problem since the appliance must then be removed for re-application of the band cement.

An alternative conventional fixed expander on the upper arch, commonly known as a bonded expander, utilizes acrylic coverage that extends onto the occlusal surfaces of the patient's dental anatomy. In some designs, the acrylic extends onto the lingual soft tissues of the palate with the intent of obtaining more anchorage. The appliance is bonded to the teeth using a strong adhesive. The active element to generate force to push apart the left and right side of the patient's dentition can be a jackscrew mechanism. Other variations of active elements are occasionally used, such as a spring or heavy wire. If a spring or a heavy wire is used, it is activated usually once by the orthodontist. A problem with the spring or heavy wire design is that the forces and amount of activation are difficult to control, resulting in insufficient or excessive expansion. For any type of bonded expander, it is extremely difficult for the patient to clean around the appliance. Since these appliances are left in place typically for several months to one year, the tissues underneath can become very raw and inflamed. Halitosis is a common complaint. Furthermore, removal of these appliances and adhesive is difficult and time-consuming.

In general, fixed expanders are generally very difficult to clean, and therefore unhygienic. Additionally, they are not removable for activities such as playing musical instruments, sports, or for talking. The patient must visit the clinical office for removal of the fixed expander at the end of treatment or when failure occurs since it is not possible for the patient to remove the appliance themselves.

A conventional removable expander is typically removably attached to the first molar and second premolar using wires such as a wire clasp. A ball clasp or a labial bow can also be used for more retention onto the teeth. The wire clasps are embedded into acrylic on the right and left sides of the appliance. The active element is typically a jackscrew mechanism that is activated by either the patient or the parent. Unlike the fixed expanders, the activation schedule of a removable appliance is much less frequent, typically at 0.25 to 0.5 mm per week. Excessive activation will overcome the retentive ability of the wire clasps resulting in a poorly fitting appliance that will not attach to the teeth and dental arch properly, resulting in poor clinical results. Indeed this is a significant drawback of this design that limits it clinical effectiveness. Additionally, the wire clasps, especially the labial bow, are visible and considered unaesthetic by some patients. However, a clear advantage of a removable design is the ability to brush and floss without obstructions.

The above prior art describes expansion appliances that are in clinical use but have the disadvantages of appearance, cleanliness, effectiveness and difficulties in removal. Therefore, an improvement upon prior art is an appliance that is aesthetic, allows for cleansing, is easily removed and is clinically effective.

### SUMMARY OF INVENTION

In contrast to prior apparatus and systems, this invention describes a thin, substantially clear removable expansion appliance used in the field of orthodontics and dentistry. The removable expansion appliance comprises a polymeric tray with tooth receiving cavities intended to fit a patient's dentition and an expansion mechanism attached to the tray capable of producing forces perpendicular to the patient's palatal suture. The forces produce bone growth in the patient's palatal suture in patient's who are still growing, arch expansion due to tooth movement in non-growth cases, or a combination of palatal suture bone growth and tooth movement in growth cases.

In the preferred embodiment, the tray is intended to receive the patient's maxillary dentition. Preferably, the geometry of the tooth receiving cavities of the tray is identical to the patient's maxillary dental positions and therefore the tray is not intended to correct individual tooth misalignment. Alternatively, at least one of the tooth receiving cavities is slightly different than the actual position of the tooth it is intended to receive. The difference between the geometry of the tooth receiving cavity and the actual position of the patient's tooth creates tooth repositioning forces for tooth misalignment correction.

In the preferred embodiment, the polymeric portion of the tray does not extend across the patient's palatal region. Alternatively, the tray does extend across the patient's palatal region in cases where increased anchorage is necessary. Preferably, the tray has a protrusion defined by the polymeric material of the tray located on the lingual surface adjacent to the patient's first molar on both the patient's left and right side. The protrusions are reinforced with acrylic and each has a hole that extends through the protrusion in the mesial-distal direction. Alternatively, the hole extends in the labial-lingual direction. In order to manufacture the tray, wax is added to a patient's stone model in the desired location of the protrusions. The tray is manufactured by thermally forming a thin sheet of polymeric material over a stone model of the patient's dentition using a thermal pressure forming machine. Acrylic is then poured into the protrusions for reinforcement of the holes for receiving the expansion mechanism. The stone model is a positive mold of the desired shape of the tray.

In the preferred embodiment, the expansion mechanism comprises a contiguous length of wire with prongs at either end capable of being inserted into the holes of the protrusions. The length of wire extends from the prongs into the palatal cavity of the patient and forms an activation loop, otherwise known as an omega loop, at its center. When the polymeric tray is placed on the patient's dentition, the omega loop is compressed and exerts a force perpendicular to the patient's palatal suture on the lingual surface of the patient's dentition. In the preferred embodiment, the prongs of the expansion mechanism are releasable placed into the holes of the protrusions. In an alternative embodiment, the prongs are adhered inside the holes with the use of acrylic or any adhesive suitable for use in the oral environment, such as cyanoacrylate or curable dental composite material.

In another alternative embodiment, the polymeric tray has four protrusions with holes in order to receive an expansion mechanism with four legs. The expansion mechanism with four prongs has a screw with a turnkey located at the center of the device, which elongates or shortens the appliance depending on the direction the screw is turned. Four legs extend from the screw mechanism. This type of expansion appliance is commonly referred to as a Hyrax® or a screw expansion mechanism. The ends of the legs of the screw expansion mechanism can either be adhered into the holes of the protrusions or left so that it is separable from the polymeric tray. The tray can either be constructed with or without a palatal coverage section. Alternatively, the tray is constructed with a split along the area of the patient's midline and sagital suture line in order to create two separable members of the tray. Manufacturing the tray with the split is occasionally desirable in order to produce increased amounts of expansion in comparison to a tray without a split. In an alternative embodiment, the tray is manufactured without protrusions and the ends of the legs of the screw expansion mechanism are adhered to the tray with the use of acrylic.

An additional alternative embodiment includes a removable expansion appliance for the patient's mandibular dentition. The tray has two protrusions with holes that extend in the mesial-distal direction. The expansion mechanism comprises a wire that extends from the holes mesially and follows the arch shape on the lingual side of the patient's mandibular dentition.

The benefits of the described invention over prior art are that it is thin and smooth, aesthetically captures the patient's teeth for increased anchorage, and is removable by the patient for activities, such as playing musical instruments or sports, or in case of failure. Additionally, securing bands to the patient's teeth is not necessary since the polymeric shell captures the patient's teeth for appliance retention.

### BRIEF DESCRIPTION OF DRAWINGS

FIG. 1A illustrates inserting an omega loop expansion mechanism into holes in protrusions located on a maxillary tray in order to form the preferred embodiment of the removable expansion appliance.

FIG. 1B illustrates placing the preferred embodiment of the removable expansion appliance on a patient's maxillary dentition.

FIG. 1C illustrates a cross-section of a protrusion with a hole located on the patients left side of the tray.

FIG. 1D illustrates a cross-section of a protrusion with an expansion mechanism inserted in the hole of the protrusion located on the patients left side of the tray.

FIG. 1E illustrates an alternative embodiment of a tray with palatal coverage.

FIG. 1F illustrates an alternative embodiment comprising a tray with palatal coverage having a split along the location of the patient's palatal suture.

FIG. 1G shows a flowchart for manufacturing the removable expansion appliance.

FIG. 2 illustrates an alternative embodiment of an expansion mechanism comprising an overlapping loop.

FIG. 3A illustrates an alternative embodiment of a tray having holes in the labial-lingual direction in the lingually located protrusions.

FIG. 3B illustrates a cross-section of a protrusion with a labial-lingual hole located on the patients left side of the tray.

FIG. 4A illustrates an alternative embodiment of attaching a screw expansion mechanism to a tray with four protrusions having labially-lingually oriented holes.

FIG. 4B illustrates the alternative embodiment of the screw expansion mechanism placed in the holes of the protrusion located on the lingual side of the tray.

FIG. 4C illustrates an alternative embodiment of a tray without palatal coverage having a split located at the patient's midline.

FIG. 5 illustrates an extended protrusion filled for increasing the rigidity of the lingual side of the tray.

FIG. 6 illustrates an alternative embodiment of a mandibular expansion appliance.

FIG. 7 illustrates an alternative expansion appliance comprising two members designed to extend into the interproximal area of desired dental expansion.

FIG. 8 illustrates an alternative embodiment of a tray designed to only receive a portion of the patient's teeth.

FIG. 9A illustrates an alternative embodiment of positioning a screw expansion mechanism on a tray without protrusions in order to bond the expansion mechanism to the tray with acrylic.

FIG. 9B illustrates the screw expansion mechanism bonded to the tray without protrusions with acrylic.

FIG. 9C illustrates a cross-section of a prong of the screw expansion mechanism bonded to the tray without protrusions with acrylic located on the patients left side of the tray.

FIG. 9D illustrates the screw expansion mechanism bonded with acrylic to a tray having palatal coverage.

FIG. 9E illustrates the screw expansion mechanism bonded with acrylic to a tray having a split along the patient's palatal suture.

### DETAILED DESCRIPTION

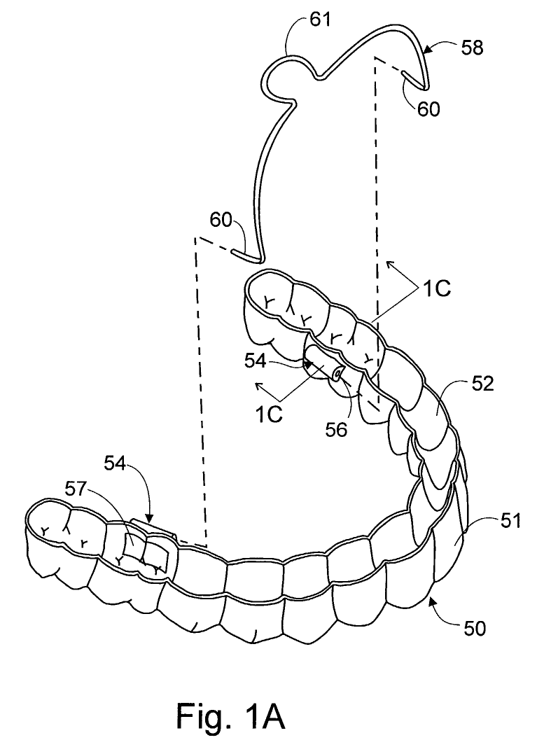

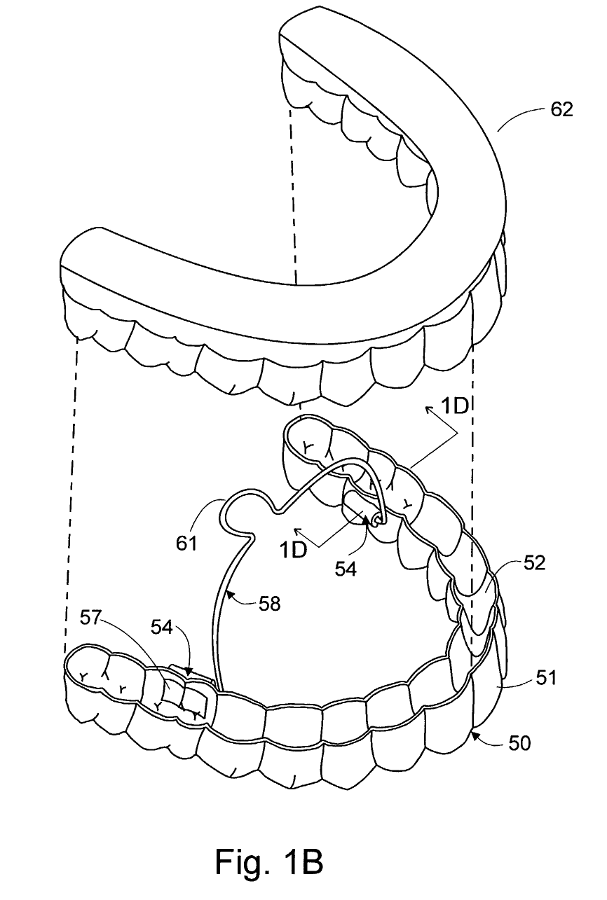

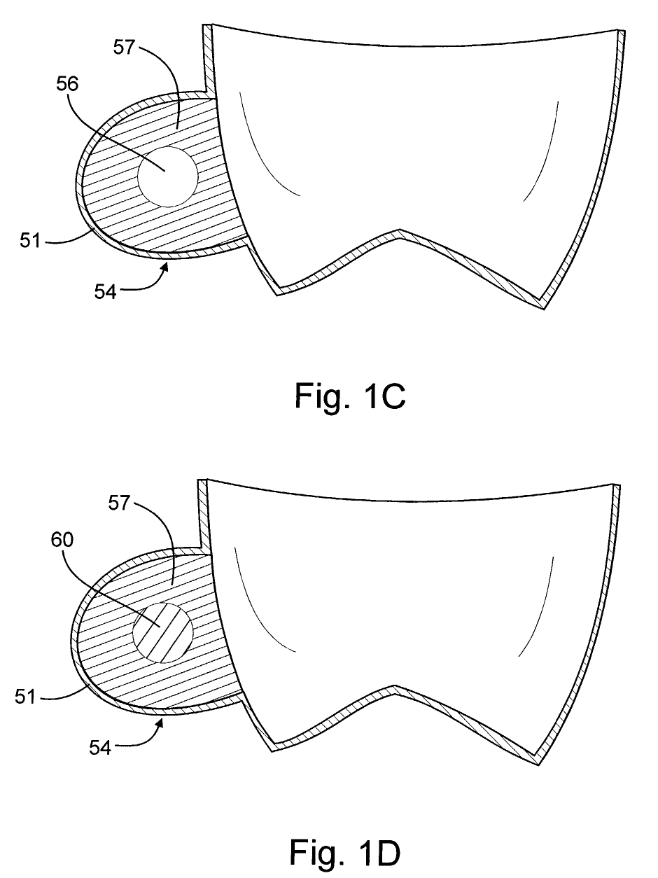

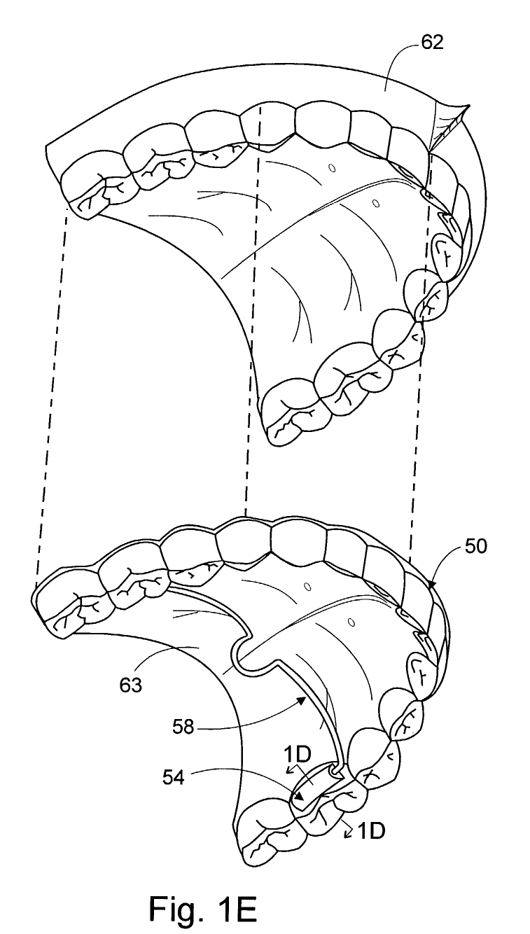

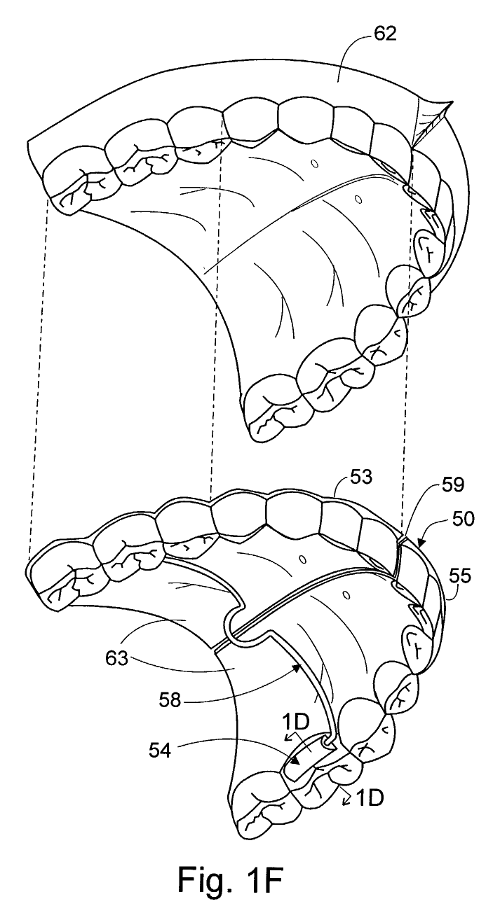

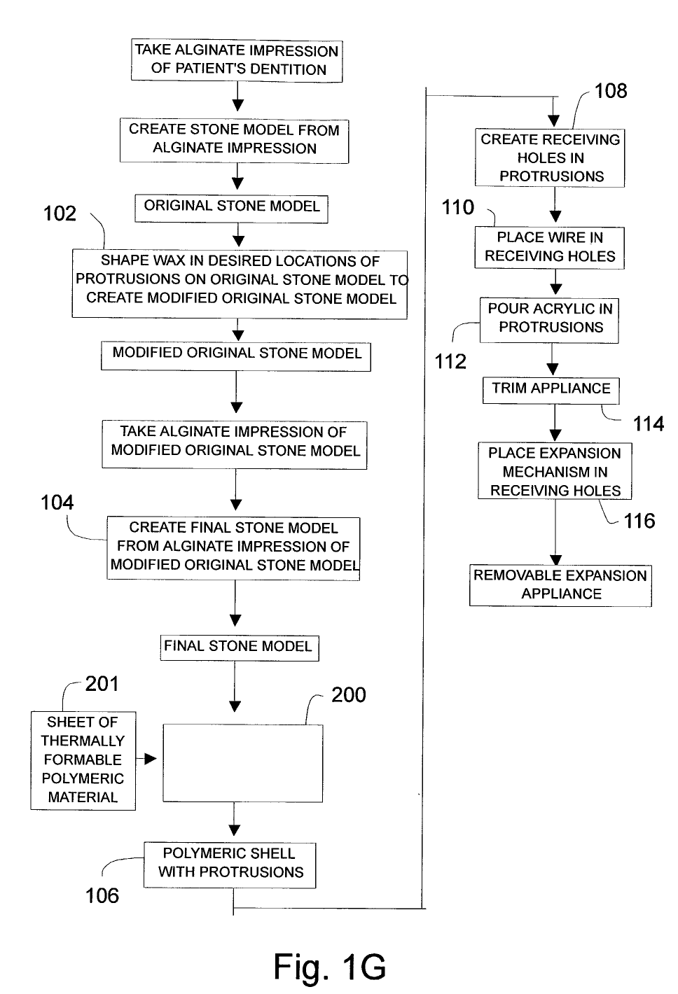

FIG. 1A illustrates a general configuration of a preferred embodiment of a removable expansion appliance. The removable expansion appliance comprises a polymeric tray 50 constructed from a substantially clear polymeric material 51 and has a tooth receiving surface 52 intended to receive the dentition of a patient's maxillary dental set. Preferably, material 51 is less than 0.060 inches thick. The thickness of material 51 varies since it is formed from a sheet of thermally deformable polymeric material described ensuingly. Preferably, surface 52 matches the positions of the patient's dentition. Alternatively, at least one tooth receiving cavity of surface 52 is slightly different than the actual tooth position it is intended to receive. Providing at least one tooth receiving cavity having a slightly different geometry than the actual tooth position of the tooth it is intended to receive is occasionally desirable when the practitioner wishes to induce individual tooth corrections during expansion. The difference between the geometry of the tooth receiving cavity and the actual tooth position provides tooth repositioning forces. Alternatively, one or more teeth of the patient's dentition has an attachment appliance which surface 52 is designed to receive.

Referring to FIG. 1A, a lingual surface of tray 50 defines the side of tray 50 adjacent to the patient's tongue. A labial surface of tray 50 defines the side adjacent to the patient's cheek and lip tissue. A mesial side is defined as an anterior side in reference to the patient's anatomy. A distal side is defined as a posterior side in reference to the patient's anatomy. Tray 50 has a protrusion 54 located on both the patient's left and right side on the lingual surface of tray 50. Protrusion 54 is filled with a material 57. Preferably, material 57 is acrylic. Alternatively, material 57 is silicone, plastic, or dental composite material. Alternatively, protrusion 64 is void and is not filled with material 57. A hole 56 generally positioned in a mesial-distal direction in reference to the patient's dentition is surrounded by material 57 and extends through protrusion 54. Preferably, hole 56 extends from the mesial side of protrusion 54 to the distal side of protrusion 54. Each hole 56 of each protrusion 54 is intended to receive an end of a leg or prong 60 located at the end of an expansion mechanism 58.

Referring again to FIG. 1A, expansion mechanism 58 comprises two prongs 60 located at the ends of legs extending away from a centrally located activation or omega loop 61. Expansion mechanism 58 generally follows the contour of the patient's palatal cavity and loop 61 is a semi-oval shape located approximately midway between prongs 60. Preferably, loop 61 has a diameter of 10 mm. Alternatively, loop 61 has a diameter between 6 mm and 14 mm. Preferably, expansion mechanism 58 is constructed from 0.036 inch diameter stainless steel. Alternatively, expansion mechanism 58 is constructed from a wire having a diameter ranging from 0.025 inches to 0.060 inches. Alternatively, expansion mechanism 58 is constructed from nickel-titanium, titanium alloy, or plastic. Preferably, expansion mechanism 58 is removable from holes 56 and is held in place due to friction between prongs 60 and material 57 that surrounds holes 56. Occasionally, the practitioner may use a stainless steel braided tie, used commonly in the field of orthodontics for securing archwires in bracket slots, to secure prongs 60 in holes 56. Alternatively, expansion mechanism 58 is rigidly secured into holes 56 with the use of acrylic, a curable resin, or composite material commonly used in orthodontics.

FIG. 1B illustrates placing the preferred embodiment of the removable expansion appliance on the patient's dentition. Referring to FIG. 1B, tray 50, with expansion mechanism 58 inserted into holes 56 of protrusions 54, is placed on a patient's maxillary dentition 62. Preferably, expansion mechanism 58 produces a force in a labial direction (perpendicular to the patient's palatal suture) on dentition 62 through protrusions 54. The force is generated by the compression of expansion mechanism 58 when tray 50 is fitted onto dentition 62. The internal forces produced in expansion mechanism 58 due to compression when tray 50 is placed on dentition 62 produces forces generally perpendicular to the patient's palatal suture in an outward direction. These forces eventually produce an expansion of dentition 62 resulting from bone growth in the patient's palatal suture in patient's who are still growing, labial crown tipping and labial tooth movement in non-growth cases, or a combination of palatal suture bone growth and tooth movement in growth cases.

FIG. 1C illustrates a cross-section of the patient's left side of tray 50 without the expansion mechanism inserted into hole 56. Hole 56 is surrounded by material 57. Material 57 is bounded by material 51 on the lingual surface. Material 57 is shaped so as not to interfere with inserting the patient's dentition against the tooth receiving surface. Preferably, material 57 is acrylic. Alternatively, material 57 is a light curable resin commonly used in the field of orthodontics and dentistry. Alternatively, material 57 is silicone, metal, plastic or a composite material. FIG. 1D illustrates a cross-section of the patient's left side of tray 50 with the expansion mechanism in place. Prong 60 is placed in the hole through protrusion 54.

FIG. 1E illustrates an alternative embodiment of tray 50 with a palatal coverage section 63. Palatal section 63 is a one-piece construction with the tooth receiving surface of tray 50. Occasionally, palatal section 63 is desirably when additional anchorage is necessary for appliance retention to the patient's dentition. FIG. 1F illustrates an additional alternative embodiment of tray 50 having a split 59 that extends in the mesial-distal direction along the entire length of tray 50. Split 59 is formed using a rotary saw to cut along the location of the palatal suture of tray 50. Alternatively, split 59 does not extend along the entire length of tray 50. Split 59 forms a patient's right side tray 53 and a patient's left side tray 55 of tray 50. Generally, split 59 extends along the patient's palatal suture. Occasionally it is desirable to have split 59 dividing tray 50 into a separable right and left side in order to allow the tray to expand to the amount necessary for desired treatment results.

FIG. 1G shows a flowchart of the manufacturing steps involved for construction of the preferred embodiment of the removable expansion appliance. An alginate impression is taken of the patient's maxillary dentition. A stone model is created from the alginate impression in order to create an original stone model. A step 102 involves shaping a piece of wax on the original stone model in the desired locations of protrusions 54 illustrated in FIG. 1A. Referring again to FIG. 1G, the wax is shaped and smoothed with wax shaping instruments commonly used in the field of dentistry. Preferably, the protrusions have a semi-cylindrical shape. The radius of the semi cylinder is generally 0.25 inches in the labial-lingual direction. The length of the semi-cylinder is 0.3 inches in the mesial-distal direction. Preferably, the wax shapes are placed on the lingual surface of the first molar. Alternatively, the wax shapes are placed according to the specifics of the patient's dental anatomy. Completion of step 102 produces a modified original stone model. The modified original stone model has the wax shapes that will define the shape of the protrusion located on the polymeric tray of the removable expansion appliance. An alginate impression is taken of the modified original stone model. A step 104 involves creating a final stone model from the alginate impression of the modified original stone model. Alternatively, one or more teeth of the modified original stone model are separated using a hand saw and then placed in a slightly different position than their original positions prior to creating the final stone model. The teeth should be moved in less than 1 mm increments, preferably at increments of 0.2 mm. Alternatively, a movement increment larger than 1 mm is used. The final stone model is created from the alginate impression of the modified stone model.

Referring again to FIG. 1G, the final stone model is placed inside a thermal pressure forming machine 200. An appropriate thermal pressure forming machine is available from Great Lakes Orthodontics, Ltd., Tonawanda, N.Y. 14150. A sheet of thermally formable polymeric material 201 is thermally pressure formed over the final stone model in order to create a polymeric shell with protrusions 106. An appropriate sheet 201 is 0.060 inch thick Essix® available from RainTree Essix, New Orleans, La. 70002. Due to stretching of sheet 201 during the thermal forming process, the thickness of the final appliance is thinner than the thickness of sheet 201 prior to the thermal pressure forming process. Alternatively, a sheet ranging from 0.005 to 0.120 is used.

Referring again to FIG. 1G, step 108 involves using a drill or heated piece of wire to create a hole at the mesial and distal sides of the protrusions. Step 110 involves placing a wire of 0.040 inch diameter through the holes of each protrusion. Step 112 involves pouring liquid acrylic into the protrusions with the 0.040 inch diameter wire placed in the hole. The wire should be rotated every three minutes while the acrylic is curing to prevent the acrylic from permanently bonding to the wire. Once the acrylic has cured, the wire is removed from the protrusion. Step 114 involves removing the unnecessary sections the polymeric shell. Preferably, the palate and gingival regions are removed using a pair of scissors or a rotary burr, leaving only the dental section of the appliance. Alternatively, the palatal section of the appliance is not removed. Preferably, the 0.036 inch wire diameter omega loop expansion mechanism, available from Dynaflex® St. Louis, Mo. 63114, is placed inside the holes of the protrusions during step 116 in order to create a completed removable expansion appliance.

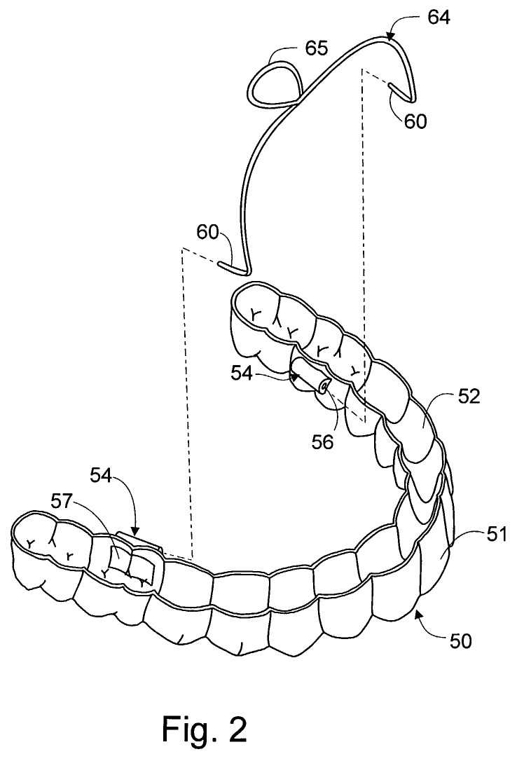

Referring to FIG. 2, in an alternative embodiment, an expansion mechanism 64 has an activation loop or overlapping loop 65 in approximately the center of the length of wire. Alternatively, the expansion mechanism has a plurality of overlapping loops.

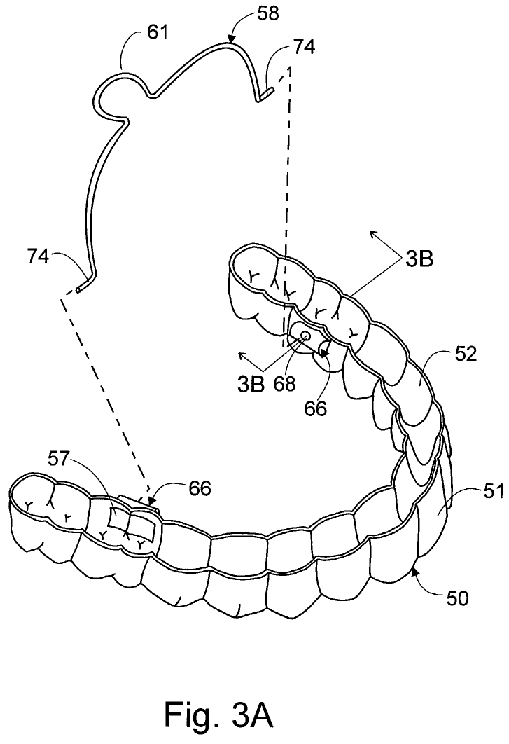

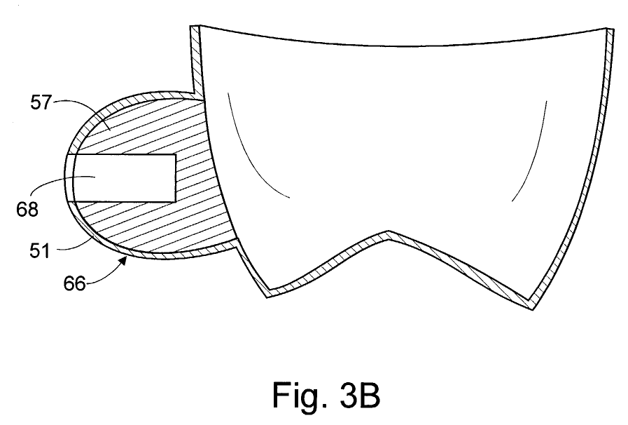

Alternatively, referring to FIG. 3A, tray 50 has lingually positioned protrusions 66 having holes 68 positioned in the lingual-labial direction. Expansion mechanism 58 has prongs 74 positioned in the labial-lingual direction and loop 61 positioned in approximately the center of the length of wire. FIG. 3B illustrates a cross section of the patient's left side of tray 50 illustrated in FIG. 3A. The entrance of hole 68 is positioned lingually. Hole 68 does not extend all the way through material 57. Alternatively, hole 68 does extend all the way through material 57.

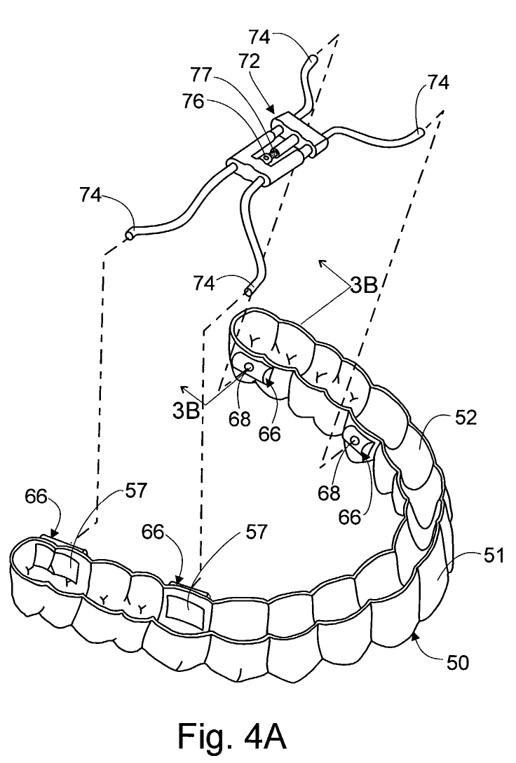

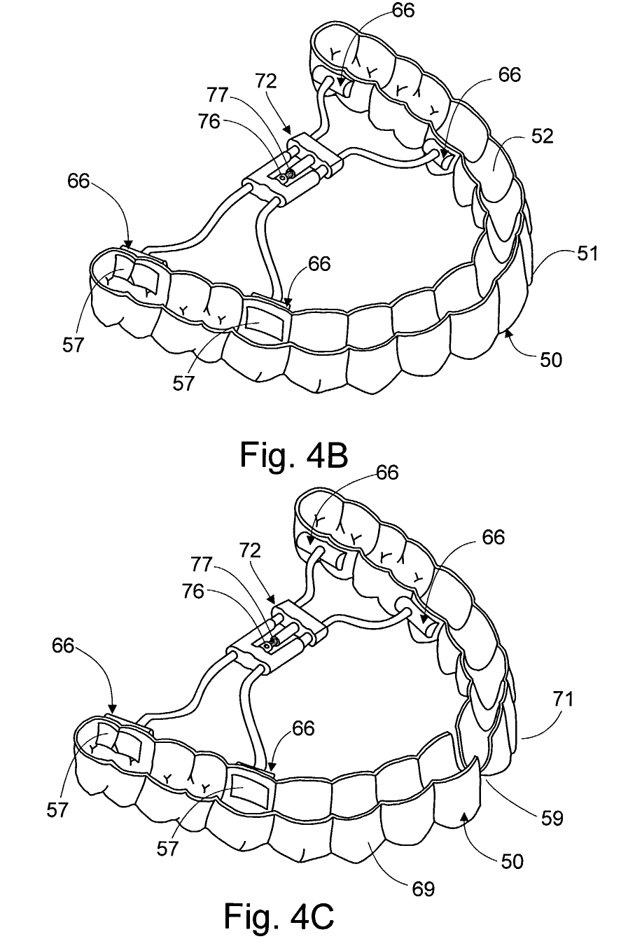

Referring to FIG. 4A, tray 50 has four protrusions 66 placed lingually. Two of the protrusions are placed on the lingual side adjacent to the tooth receiving cavity for the patient's second molar, and two of the protrusions are placed lingually adjacent to the tooth receiving cavity for the patient's second bicuspid. Alternatively, protrusions 66 are placed dependent upon the particularities of a patient's dental anatomy. Protrusions 66 have holes 68 in the labial-lingual direction to receive prongs 74 of a screw expanding mechanism 72. Mechanism 72 has four prongs 74 located at the ends of legs extending away from the center of mechanism 72. Mechanism 72 has a turnkey hole 76 that turns a threaded rod 77 located in a tubular shaped actuating structure, thus expanding or contracting the total width of mechanism 72 in the labial-lingual direction. Mechanism 72 is available from Great Lakes Orthodontics, Ltd., Tonawanda, N.Y. 14150. Preferably, prongs 74 are detachable from holes 68. Alternatively, at least one of prongs 74 is adhered inside respective receiving hole 68. Alternatively, all of prongs 74 are adhered inside holes 68. Suitable adhesives include acrylic, silicone, cyanoacrylate or curable orthodontic or dental composite material commonly used as an adhesive. The turnkey hole is rotated one-quarter turn every day in order to expand mechanism 72 approximately 0.25 mm per day. Alternatively, different rtes of expansion are utilized dependent upon the practitioner's treatment plan. FIG. 4B illustrates mechanism 72 inserted into protrusions 66.

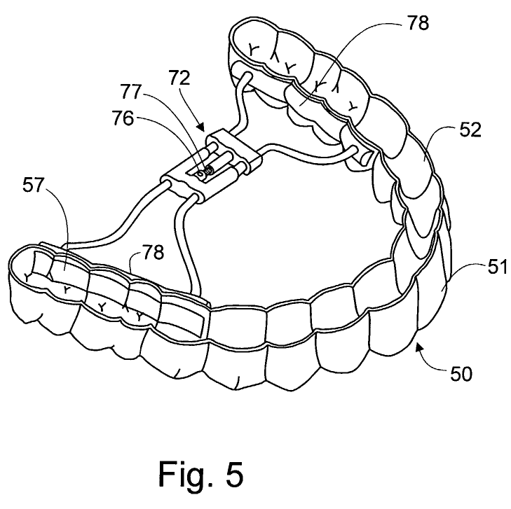

FIG. 4C illustrates an alternative embodiment of tray 50 comprising a split 59 with mechanism 72 inserted into protrusions 66. Tray 50 illustrated in FIG. 4C does not have a palatal coverage area. Split 59 extends along the tooth receiving surface of tray 50 between the patient's maxillary centrals. Alternatively, split 59 is placed at a different location of tray 50 dependent upon the particularities of a patient's dental anatomy. Split 59 forms a patient's left side tray 71 and a patient's right side tray 69. Tray 71 and tray 69 have tooth receiving surfaces without any substantial palatal coverage. Alternatively, tray 71 and tray 69 have additional palatal coverage in cases where additional anchorage is necessary. Alternatively, referring to FIG. 5, a protrusion 78 spans several teeth on both the patient's left and right side of the lingual surface of tray 50. Protrusion 78 is filled with material 57 with the hole extending through material 57. Alternatively, protrusion 78 is hollow.

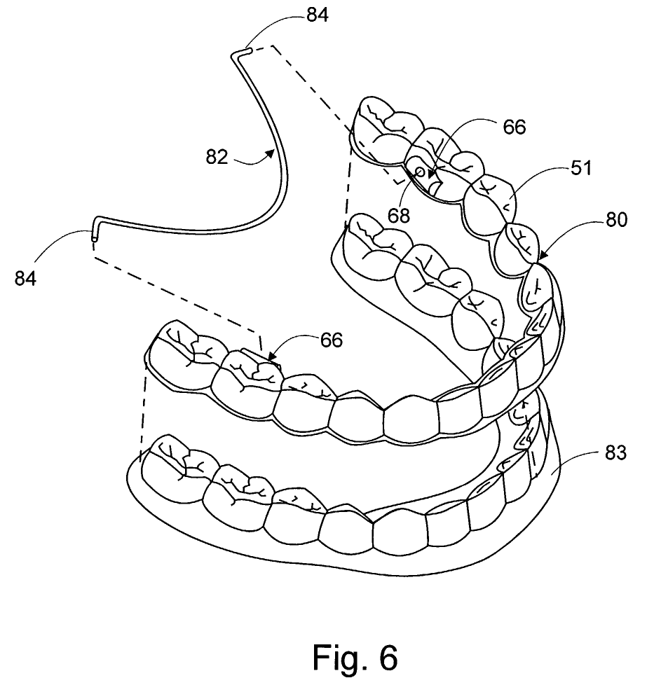

Alternatively, referring to FIG. 6, a removable mandibular expansion appliance comprises a polymeric tray 80 constructed from material 51 and has a tooth receiving surface intended to receive the dentition of a patient's mandibular dental set 83. Tray 80 has protrusion 66 located on both the patient's left and right side on the lingual surface of tray 80. Hole 68 of protrusion 66 on the patient's right side of tray 80 is not shown for illustration perspective purposes, however protrusion 66 with hole 68 on the patient's right side is a mirror image of protrusion 66 with hole 68 located on the patient's left side. An expansion mechanism 82 has a general configuration of an arc and has a prong 84 located at either end of the mechanism 82. Mechanism 82 generally extends in the mesial direction to the apex of the arc. Preferably, mechanism 82 closely follows the lingual shape of the patient's mandibular arch. Mechanism 82 is generally constructed from stainless steel wire with a diameter of 0.036 inches. Alternatively, mechanism 82 is constructed from wire with a diameter ranging from 0.025 inches to 0.060 inches. Alternatively, mechanism 82 is constructed from nickel-titanium, beta-titanium or molybdenum alloy, plastic or combination thereof. Both of the holes 68 are intended to receive prongs 84. Prongs 84 are generally adhered inside holes 68 with the use of acrylic, silicone, or a curable composite material commonly used in the field of orthodontics and dentistry.

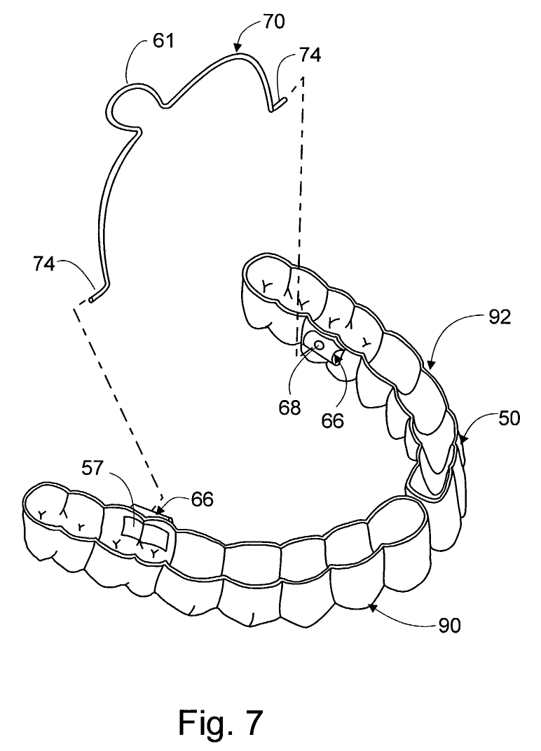

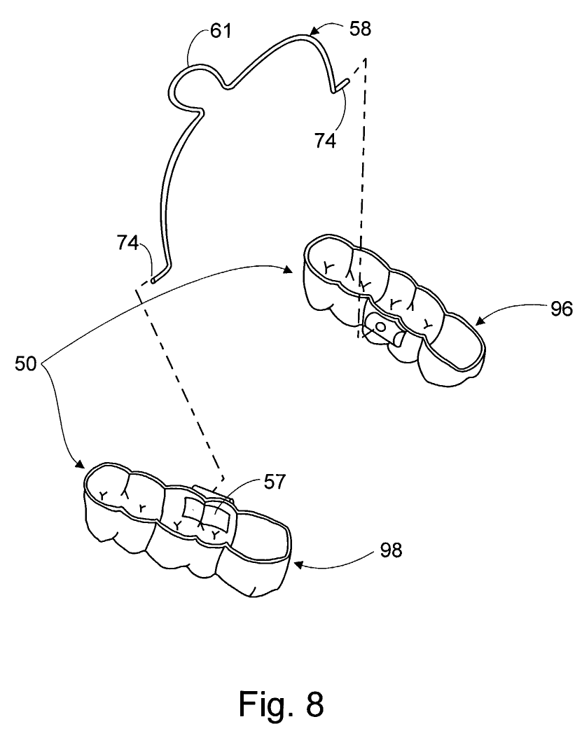

Alternatively, referring to FIG. 7, tray 50 comprises a left tray 90 and a right tray 92. Tray 90 and tray 92 are separated at the patient's sagital suture midline. Tray 90 and tray 92 are designed to encapsulate the patient's dentition at the sagital suture midline. Tray 90 and tray 92 each have at least one protrusion 66. Each protrusion 66 has one hole 68. Holes 68 are intended to receive prongs 74 of mechanism 58. Alternatively, referring to FIG. 8, a tray assembly 94 comprises a left tray 96 and a right tray 98. Tray 96 and tray 98 are intended to only receive a portion of the patient's dentition.

Alternatively, referring to FIG. 8, tray 50 comprises a tray 96 intended to fit only a portion of the patient's dentition on the patient's left side. A tray 98 is intended to fit only a portion of the patient's dentition on the patient's right side for tray 50.

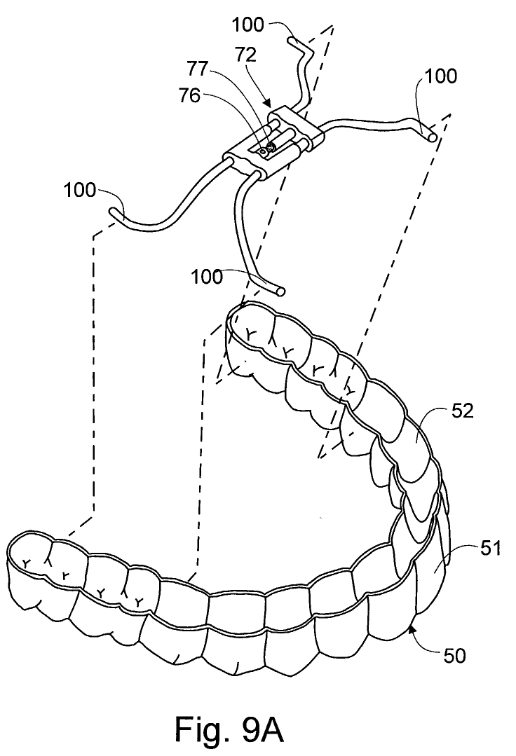

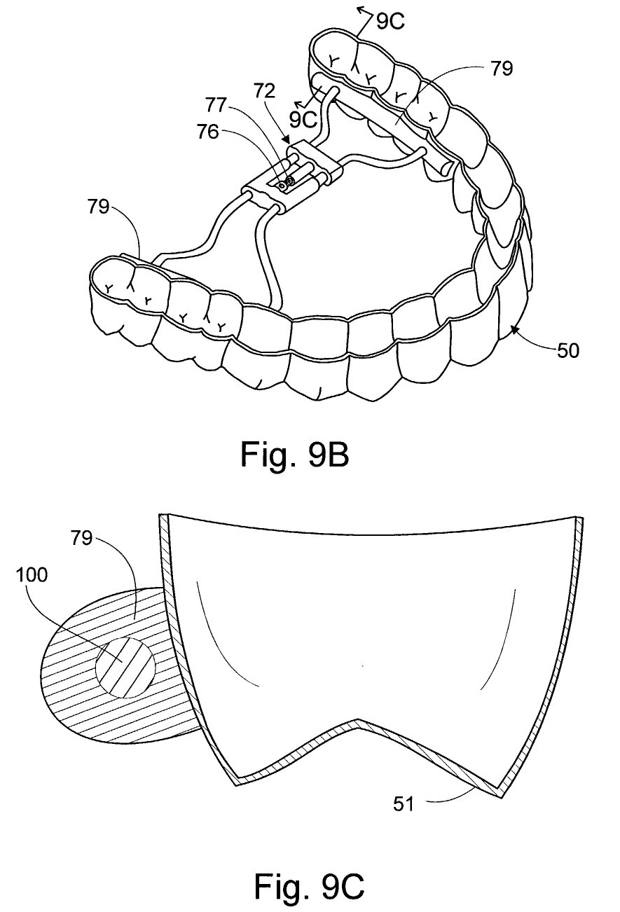

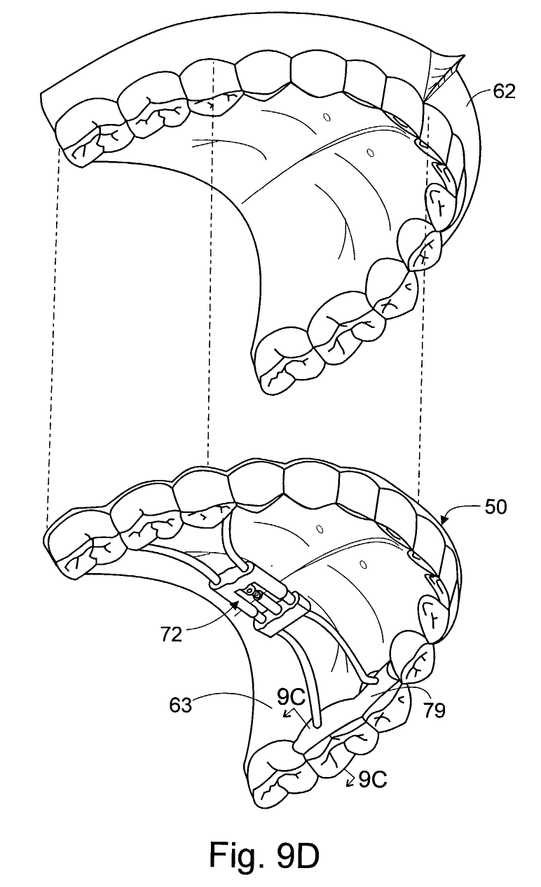

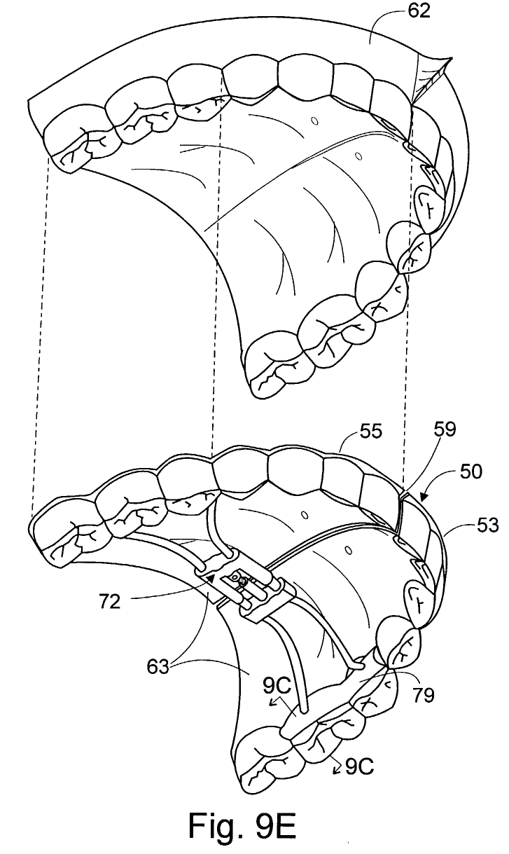

Alternatively, referring to FIG. 9A, mechanism 72 has prongs 100 bent in a general mesial-distal direction. Mechanism 72 generally has four prongs 100. Referring to FIG. 9B, prongs 100 are secured to tray 50 with the used of a bonding material 79. Preferably, bonding material 79 is liquid acrylic and is used to bond prongs 100 to tray 50. Bonding material 79 is formed to the desired shape and surrounds prongs 100 and then allowed to cure. Prongs 100 can be roughened with light sanding in order to improve adhesion with the acrylic. FIG. 9C illustrates a cross-section of the patient's left side of tray 50. Material 57 encapsulates prong 100 and provides a bond between prong 100 and material 51. In an alternative embodiment, referring to FIG. 9D, tray 50 has palatal section 63 for anchorage purposes. Alternatively, referring to FIG. 9E, tray 50 has split 59 that separates tray 50 into tray 55 and tray 53.

While the above description contains many specificities, these should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

What is claimed is:

1) An improved, substantially thin, removable expansion appliance comprising:
a. A substantially thin, flexible polymeric shell with tooth receiving cavities meant to receive a patient's dentition and;
b. Said polymeric shell having two lingually positioned protrusions and;
c. Said lingually positioned protrusions each having a hole meant to receive an end of an expansion mechanism and;
d. Said expansion mechanism comprising a length of wire with the opposing ends placed inside the holes of said lingually positioned protrusions;
Whereby said tooth receiving cavities capture the patient″s teeth in order to provide anchorage for said removable expansion appliance;
Whereby said removable expansion appliance is removable by the patient.

2) The removable expansion appliance of claim 1 wherein said holes extend through acrylic in said protrusions.

3) The removable expansion appliance of claim 1 further including a palatal coverage area.

4) The removable expansion appliance of claim 3 further including a split in a mesial-distal direction.

5) The removable expansion appliance of claim 1 further including at least one split.

6) The removable expansion appliance of claim 1 wherein the tooth receiving cavities are designed to receive the actual positions of the patient's dentition.

7) The removable expansion appliance of claim 1 wherein said flexible polymeric shell comprises at least one tooth receiving cavity different than the actual position of a tooth of said patient's dentition said tooth receiving cavity is intended to receive.

8) The removable expansion appliance of claim 1 further including said length of wire comprising an activation loop.

9) The removable expansion appliance of claim 1 wherein said tooth receiving surface is designed to only receive a portion of the patients dentition.

10) The removable expansion appliance of claim 1 where said tooth receiving surface is designed to receive at least one attachment appliance bonded to the surface of the patient's dentition.

11) An improved, substantially thin, removable expansion appliance comprising:
a. A substantially thin, flexible polymeric shell with tooth receiving cavities meant to receive a patient's dentition and;
b. Said substantially thin polymeric shell having at least two lingually positioned protrusions and;
c. Said lingually positioned protrusions each having a hole meant to receive an end of a leg of an expansion mechanism and;
d. Said expansion mechanism comprising a screw in a tubular shaped structure for altering the width of said expansion appliance and;
e. Said legs with said ends extending away from said tubular shaped structure and;
f. Said ends of said legs inserted into said holes;
Whereby said tooth receiving cavities capture the patient's teeth in order to provide anchorage for said removable expansion appliance and said removable expansion appliance is removable by the patient;
Whereby said expansion mechanism is shaped to the contour of a patient's palatal region.

12) The removable expansion appliance of claim 11 wherein said holes extend through acrylic in said protrusions.

13) The removable expansion appliance of claim 11 further including a palatal coverage area.

14) The removable expansion appliance of claim 13 further including a split in a mesial-distal direction.

15) The removable expansion appliance of claim 11 further including a split.

16) The removable expansion appliance of claim 11 wherein the tooth receiving cavities are designed to receive the actual positions of the patient's dentition.

17) The removable expansion appliance of claim 11 wherein said flexible polymeric shell comprises at least one tooth receiving cavity different than the actual position of a tooth of said patient's dentition said tooth receiving cavity is intended to receive.

18) The removable expansion appliance of claim 11 wherein said tooth receiving surface is designed to only receive a portion of the patient's dentition.

19) The removable expansion appliance of claim 11 where said tooth receiving surface is designed to receive at least one attachment appliance bonded to the surface of the patients dentition.

20) A method of expanding an arch of a patient's dentition comprising:
a. Providing a substantially thin, flexible polymeric shell with tooth receiving cavities meant to receive a patient's dentition and;
b. Providing an expansion means for creating a force substantially perpendicular to the patient's palatal suture and;
c. Providing an adjoining means for securing said expansion means to said polymeric shell;
Whereby said tooth receiving cavities capture the patients teeth in order to provide anchorage for said removable expansion appliance;
Whereby said removable expansion appliance is removable by the patient.

21) An improved, substantially thin, removable expansion appliance comprising:
a. A substantially thin, flexible polymeric shell with tooth receiving cavities meant to receive a patient's dentition and;
b. An expansion mechanism comprising a screw in a tubular shaped structure for altering the width of said expansion appliance and;
c. Legs extending away from said tubular shaped structure and;
d. Said prongs located at the ends of legs and;
e. Said prongs adhered with acrylic to the lingual surface of said polymeric shell;
Whereby said tooth receiving cavities capture the patient's teeth in order to provide anchorage for said removable expansion appliance and said removable expansion appliance is removable by the patient;
Whereby said removable expansion mechanism is shaped to the contour of a patient's palatal region.

22) The removable expansion appliance of claim 21 further including said polymeric shell having a palatal coverage area.

23) The removable expansion appliance of claim 22 further including a split in a mesial-distal direction.

24) The removable expansion appliance of claim 21 further including a split.

25) The removable expansion appliance of claim 21 wherein the tooth receiving cavities are designed to receive the actual positions of the patient's dentition.

26) The removable expansion appliance of claim 21 wherein said polymeric shell comprises at least one tooth receiving cavity different than the actual position of a tooth of said patient's dentition said tooth receiving cavity is intended to receive.

27) An improved, substantially thin, removable expansion appliance comprising:
a. A substantially thin, flexible polymeric shell with tooth receiving cavities meant to receive a patient's dentition and;
b. An expansion mechanism comprising a length of wire with the opposing ends adhered with acrylic to the lingual surface of said polymeric shell;
Whereby said tooth receiving cavities capture the patients teeth in order to provide anchorage for said removable expansion appliance;
Whereby said removable expansion appliance is removable by the patient.

28) The removable expansion appliance of claim 27 further including said polymeric shell having a palatal coverage area.

29) The removable expansion appliance of claim 28 further including a split in a mesial-distal direction.

30) The removable expansion appliance of claim 27 further including a split.

31) The removable expansion appliance of claim 27 wherein the tooth receiving cavities are designed to receive the actual positions of the patient's dentition.

32) The removable expansion appliance of claim 27 wherein said polymeric shell comprises at least one tooth receiving cavity different than the actual position of a tooth of said patient's dentition said tooth receiving cavity is intended to receive.
